(19) United States
(12) Patent Application Publication
(10) Pub. No.: US 2026/0288391 A1
(43) Pub. Date: Sep. 24, 2026

(54) NON-TRANSITORY COMPUTER-READABLE STORAGE MEDIUM STORING PRINTING CONTROL PROGRAM, INFORMATION PROCESSING APPARATUS, AND CONTROL METHOD

(71) Applicant: SEIKO EPSON CORPORATION, Tokyo (JP)

(72) Inventor: Yusuke MASE, Shiojiri (JP)

(21) Appl. No.: 19/567,568

(22) Filed: Mar. 16, 2026

(30) Foreign Application Priority Data
Mar. 18, 2025 (JP) 2025-043646

(51) Int. Cl. G06F 3/12; H04N 1/00

(52) U.S. Cl. CPC G06F 3/1232; G06F 3/1204; G06F 3/1205; G06F 3/1217; G06F 3/1254; G06F 3/1255; H04N 1/00395; H04N 1/00413; H04N 1/00474; H04N 2201/0094

(57) ABSTRACT

According to the present disclosure, there is provided a non-transitory computer-readable storage medium storing a printing control program for extending a general-purpose printing program, the printing control program causing a computer to execute: acquisition processing of acquiring information indicating print languages usable by a printer; user interface processing of displaying a first user interface screen including, as options, the print languages indicated by the information, and accepting selection by a user regarding the print language; and transmission processing of transmitting, to the printer, print data in accordance with the selected print language.

The present application is based on, and claims priority from JP Application Serial Number 2025-043646, filed March 18, 2025, the disclosure of which is hereby incorporated by reference herein in its entirety.

### BACKGROUND

### 1. Technical Field

The present disclosure relates to a non-transitory computer-readable storage medium storing a printing control program, an information processing apparatus, and a control method.

### 2. Related Art

Until now, in general, when print data is transmitted from an information processing apparatus to a printer, a printer driver supplied by a vendor that provides the printer (hereinafter also referred to as a vendor-specific driver) is used. However, in recent years, as disclosed in JP-A-2024-140680, in place of using such a vendor-specific driver, a general-purpose printer driver such as an operating system (OS) standard printer driver is being used.

When use of the vendor-specific driver is possible, with respect to an information processing apparatus, as printer drivers for the same printer, a plurality of types of printer drivers having different print languages may be installed. Then, when the plurality of types of printer drivers having different print languages are installed in the information processing apparatus as printer drivers for the same printer, a user can easily select a printer driver to use, that is, a print language to use.

However, when the general-purpose printer driver is used, with the currently provided technology, it is not possible to freely set the print language. Therefore, upon printing using the information processing apparatus into which the general-purpose printer driver is introduced, development of a technology that makes it possible to freely set a print language to use is desired.

### SUMMARY

According to an aspect of the present disclosure, there is provided a non-transitory computer-readable storage medium storing a printing control program for extending a general-purpose printing program, the printing control program causing a computer to execute: acquisition processing of acquiring information indicating print languages usable by a printer; user interface processing of displaying a first user interface screen including, as options, the print languages indicated by the information, and accepting selection by a user regarding the print language; and transmission processing of transmitting, to the printer, print data in accordance with the selected print language.

According to another aspect of the present disclosure, there is provided an information processing apparatus including a general-purpose printing program and a printing control program for extending the general-purpose printing program, the information processing apparatus including, as functions of the printing control program: an acquisition processing section that acquires information indicating print languages usable by a printer; a user interface processing section that displays a first user interface screen including, as options, the print languages indicated by the information, and accepts selection by a user regarding the print language; and a transmission processing section that transmits, to the printer, print data in accordance with the selected print language.

According to still another aspect of the present disclosure, there is provided a control method comprising: causing a computer including a general-purpose printing program and a printing control program for extending the general-purpose printing program to execute, by execution of the printing control program: acquisition processing of acquiring information indicating print languages usable by a printer; user interface processing of displaying a first user interface screen including, as options, the print languages indicated by the information, and accepting selection by a user regarding the print language; and transmission processing of transmitting, to the printer, print data in accordance with the selected print language.

### BRIEF DESCRIPTION OF THE DRAWINGS

FIG. 1 is a block diagram showing a configuration example of a printing system according to an embodiment.

FIG. 2 is a block diagram showing components provided in an information processing apparatus according to Embodiment 1 as functions of a printing control program.

FIG. 3 is a schematic diagram showing an example of a UI screen for selection of a print language.

FIG. 4 is a sequence chart showing an example of an operation of the printing system according to Embodiment 1.

FIG. 5 is a schematic diagram showing an example of a UI screen for designating a print setting.

FIG. 6 is a block diagram showing components provided in an information processing apparatus according to Embodiment 2 as functions of the printing control program.

FIG. 7 is a schematic diagram showing an example of the UI screen for selection of the print language.

FIG. 8 is a sequence chart showing an example of an operation of a printing system according to Embodiment 2.

### DESCRIPTION OF EMBODIMENTS

Hereinafter, embodiments and the like will be described with reference to the drawings. For clarification of description, the following description and the drawings will be omitted and simplified as appropriate. Additionally, in the drawings, the same elements are assigned the same reference numerals, and overlapping description is omitted as necessary. Further, in order to describe exemplary embodiments, not all features or steps shown in any one figure are necessarily essential, and a part of the features or steps may be omitted. Furthermore, an order of steps described in any figure may be changed as appropriate.

### Embodiment 1

An information processing apparatus according to the present embodiment is an apparatus that is connected to a printer and that can instruct the printer to print. The information processing apparatus constitutes a printing system together with the printer.

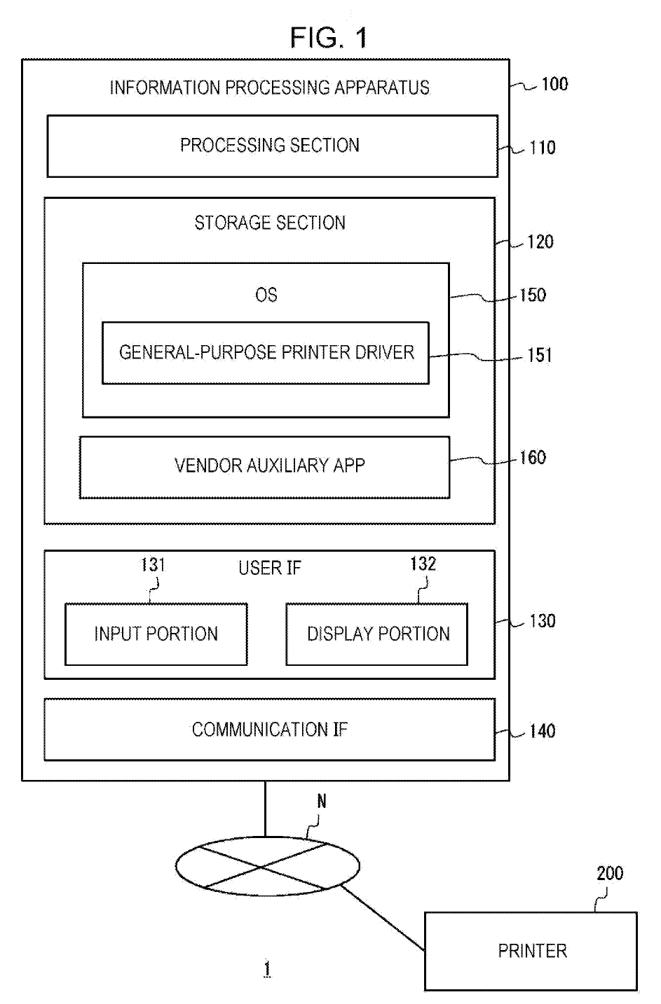

Hereinafter, a configuration example of the printing system including the information processing apparatus according to the present embodiment will be described with reference to FIG. 1. FIG. 1 is a block diagram showing a configuration example of the printing system according to the present embodiment.

As shown in FIG. 1, a printing system 1 according to the present embodiment includes an information processing apparatus 100 and a printer 200. Although one printer 200 is shown in FIG. 1, the printing system 1 may include a plurality of printers 200. The printing system 1 may include a plurality of information processing apparatuses 100.

The information processing apparatus 100 is a terminal apparatus having a communication function, such as a personal computer (PC), a smartphone, or a tablet-type terminal, and is used by a user who desires printing. The information processing apparatus 100 is connected to the printer 200 via a network N for processing of transmitting print data and the like. The information processing apparatus 100 and the printer 200 may be directly connected without passing through the network N.

When the printer 200 receives print data expressed in a predetermined print language, the printer 200 interprets the print data in accordance with the print language and executes printing processing in accordance with the print data. Consequently, the printer 200 performs printing in accordance with the print data on a medium such as paper. The printer 200 can interpret at least one type of print language. That is, the printer 200 is usable with at least one type of print language. The printer 200 may be usable with a plurality of types of print languages.

The printer 200 can also be referred to as a printing apparatus, an image forming apparatus, or a multifunction peripheral. The printer 200 need only be an apparatus having a communication function and a printing function, and may be a multifunction peripheral having other functions such as a scan function, a copy function, and a facsimile function. The copy function is implemented by the scan function and the printing function. In addition, a printing method in the printer 200 is not limited; for example, various printing methods such as an ink jet printing method and a laser printing method can be applied.

Hereinafter, a configuration example of the information processing apparatus 100 will be described in detail.

As shown in FIG. 1, the information processing apparatus 100 includes, as main hardware configurations, a processing section 110, a storage section 120, a user interface (IF) 130, and a communication interface (IF) 140. The user IF 130 includes an input portion 131 and a display portion 132. The processing section 110, the storage section 120, the user IF 130, and the communication IF 140 may be mutually coupled via a data bus or the like. As will be described below, the information processing apparatus 100 is an apparatus having a function as a computer. In particular, in the present embodiment, the information processing apparatus 100 is a computer in which an operating system (OS) 150, a general-purpose printer driver 151, and a vendor auxiliary application program 160, which will be described below, are installed.

The processing section 110 is, for example, a processor such as a central processing unit (CPU), a micro-processing unit (MPU), and an application-specific integrated circuit (ASIC). The processing section 110 includes one or more processors. The processing section 110 has a function as an arithmetic device that performs control processing, arithmetic processing, and the like. The processing section 110 controls the storage section 120, the user IF 130, and the communication IF 140.

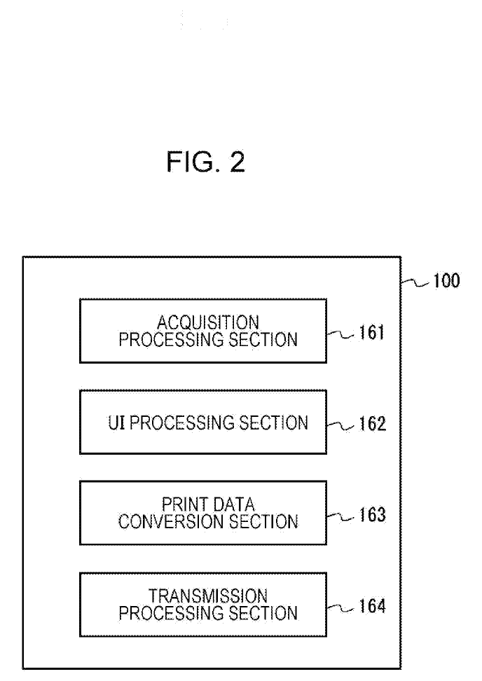

The storage section 120 is a storage device configured using one or more memories or storages, or a combination thereof. The memory is configured using a volatile memory or a nonvolatile memory, or a combination thereof. The volatile memory may be, for example, a random access memory (RAM). The nonvolatile memory may be, for example, a read-only memory (ROM). The storage may be a flash memory, a hard disk drive (HDD), or a solid-state drive (SSD). The storage section 120 has a function of storing control programs, arithmetic programs, and the like that are executed by the processing section 110. Additionally, the storage section 120 has a function of temporarily storing processing data and the like. The processing section 110 (that is, a processor) reads various programs from the storage section 120 (that is, a memory) and executes the various programs. Consequently, in the present embodiment, in particular, the processing section 110 implements functions of the vendor auxiliary application program 160, which will be described with reference to FIG. 2. Note that any function of the information processing apparatus 100, including the functions shown in FIG. 2 to be described below, may be implemented not only by software by a program but also by any combination of hardware, firmware, and software, or the like. Additionally, each component may be implemented by using, for example, a user-programmable integrated circuit such as a field-programmable gate array (FPGA) or a microcomputer. In this case, by using this integrated circuit, a program that is configured with components may be implemented.

The communication IF 140 is an interface for the information processing apparatus 100 to communicate with another device via the network N or directly. The communication IF 140 may include a communication circuit and the like.

The user IF 130 includes the input portion 131 that is an input device such as a keyboard or a pointing device. The user inputs information to the information processing apparatus 100 by operating the input portion 131. For example, by operating the input portion 131, the user can input to the information processing apparatus 100 an instruction regarding a print setting, an instruction regarding execution of printing, and the like.

In addition, the user IF 130 includes the display portion 132 that displays information. The display portion 132 is, for example, a flat-panel display such as a liquid-crystal display, a plasma display, or an organic electro-luminescence (EL) display.

The input portion 131 and the display portion 132 may be configured, for example, as a physically integrated device such as a touch screen or a touch panel.

In the present embodiment, the information processing apparatus 100 includes an operating system (OS) 150 as programs read from the storage section 120 and executed by the processing section 110. The OS 150 is basic software that controls the operation of the information processing apparatus 100. The OS 150 may be, for example, Windows (registered trademark), but the present disclosure is not limited to this. In the following description, an example in which the OS 150 is Windows will be described as appropriate.

Further, in the present embodiment, as the programs read from the storage section 120 and executed by the processing section 110, the information processing apparatus 100 includes the general-purpose printer driver 151 and the vendor auxiliary application program 160. The general-purpose printer driver 151 may be a part of the OS 150. In FIG. 1 and in the following description, the vendor auxiliary application program is abbreviated as a vendor auxiliary App.

The general-purpose printer driver 151 will be described. The general-purpose printer driver 151 is an OS-standard printer driver that is included in the OS 150 or attached to the OS 150. That is, the general-purpose printer driver 151 is a driver different from a vendor-specific driver. The general-purpose printer driver 151 is a program capable of controlling a printer and executing printing for various types of printers. That is, the general-purpose printer driver 151 is not a printer driver for a specific printer, and is a printer driver for various printers provided by various vendors. The general-purpose printer driver 151 can also be referred to as an OS general-purpose printing program or a general-purpose printing program.

The general-purpose printer driver 151 is a driver that uses general-purpose protocols for printer discovery and for printing. The general-purpose printer driver 151 uses mDNS/DNS-SD for printer discovery and uses IPP for printing at the printer, for example. Here, DNS is an abbreviation of domain name system. mDNS is an abbreviation of multicast DNS. DNS-SD is an abbreviation of DNS Service Discovery. IPP is an abbreviation of Internet Printing Protocol. Therefore, the general-purpose printer driver 151 can also be described as an OS-standard IPP class driver. IPP is an example of a standard protocol for managing the printer and controlling printing. IPP performs acquisition of printer information and control via Hyper Text Transfer Protocol (HTTP) POST requests and responses. In IPP, it is possible to perform setting of the printer and acquisition of a state of the printer. Here, by using HTTP Secure (HTTPS) instead of HTTP, it is possible to perform secure communication.

The vendor auxiliary App 160 will be described. The vendor auxiliary App 160 is an application program that assists the general-purpose printer driver 151 and is used to extend functions of the general-purpose printer driver 151. Therefore, the general-purpose printer driver 151 can have a function of launching the vendor auxiliary App 160 and a function of transmitting and receiving information to and from the vendor auxiliary App 160. Specifically, the vendor auxiliary App 160 is, for example, a print support application (PSA).

The vendor auxiliary App 160 assists the general-purpose printer driver 151 and can be a program for causing a computer to execute printing control suitable for performance of a target printer, that is, printing control of supporting unique functions of the printer. The computer used here, in the present embodiment, is the information processing apparatus 100 or the processing section 110.

The vendor auxiliary App 160 is an application program provided by a vendor of the printer or the like. That is, the vendor auxiliary App 160 is, for example, an application program developed by a vendor of the printer 200. The vendor auxiliary App 160 can be provided to the user of the information processing apparatus 100 by being published, for example, in an application store or the like of a provider of the OS. Alternatively, the vendor auxiliary App 160 can be provided to the user by being included in the OS or by being attached to the OS. The vendor auxiliary App 160 may be launched from the general-purpose printer driver 151, but may be launched without passing through the general-purpose printer driver 151.

In the present embodiment, the vendor auxiliary App 160 includes a printing control program to be described next. That is, this printing control program can also be implemented, for example, as a PSA. The printing control program is a printing control program for extending the general-purpose printer driver 151 and for causing the computer (that is, the information processing apparatus 100) to have the functions shown in FIG. 2. FIG. 2 is a block diagram showing components provided in the information processing apparatus 100 according to Embodiment 1 as functions of the printing control program. As shown in FIG. 2, the information processing apparatus 100 includes, as functions of the printing control program, an acquisition processing section 161, a user interface (UI) processing section 162, a print data conversion section 163, and a transmission processing section 164. That is, the printing control program causes the information processing apparatus 100 (computer) to execute processing of the acquisition processing section 161, the UI processing section 162, the print data conversion section 163, and the transmission processing section 164. In other words, by the processing section 110 of the information processing apparatus 100 executing the printing control program, the processing of the acquisition processing section 161, the UI processing section 162, the print data conversion section 163, and the transmission processing section 164 is executed. Note that processing as the acquisition processing section 161, processing as the UI processing section 162, processing as the print data conversion section 163, and processing as the transmission processing section 164 may be, as appropriate, also referred to as acquisition processing, user interface processing (UI processing), data conversion processing, and transmission processing.

The acquisition processing section 161 acquires information indicating a print language usable by the printer 200. The print language usable by the printer 200 can also be referred to as a print language that the printer 200 can process or a print language that the printer 200 can interpret. Note that the language usable by the printer 200 is not necessarily limited to one. That is, the printer 200 may be usable with a plurality of print languages. In this case, the acquisition processing section 161 acquires information indicating all print languages usable by the printer 200, that is, a list of usable print languages. Hereinafter, information indicating print languages that the printer 200 can process will be referred to as print language information.

The UI processing section 162 displays a UI screen including, as options, the print languages indicated by the above-described print language information acquired by the acquisition processing section 161, and accepts selection by the user regarding the print language. Specifically, the UI processing section 162 displays the UI screen on the display portion 132. The user selects, from among the options displayed on the UI screen, a print language that the user desires to use for printing by the printer 200.

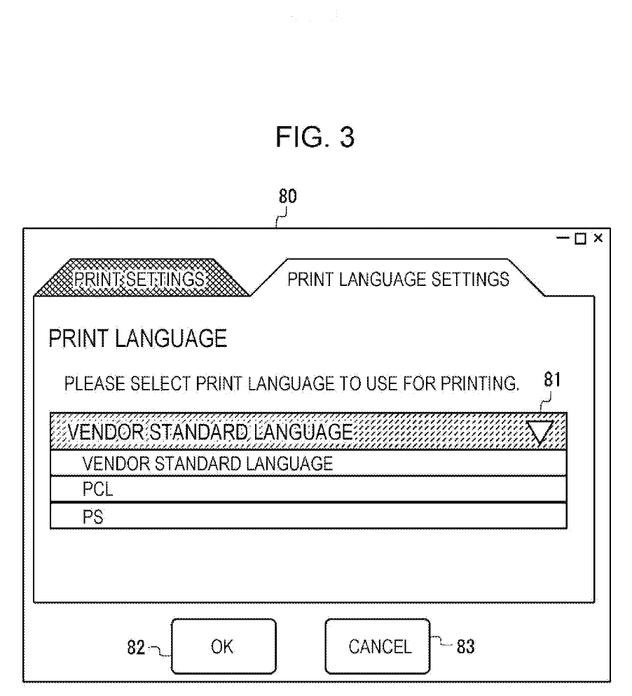

FIG. 3 is a schematic diagram showing an example of a UI screen 80 for selection of the print language. When the acquisition processing section 161 acquires the print language information usable by the printer 200, the UI processing section 162 displays, for example, the UI screen 80 as shown in FIG. 3 on the display portion 132 (that is, a display). The UI screen 80 shown as an example in FIG. 3 is a so-called graphical user interface (GUI), and includes a pull-down menu 81, a button 82, and a button 83. The pull-down menu 81 is a GUI component that displays the print languages usable by the printer 200 and that accepts selection. The button 82 is a GUI component for confirming the selection. The button 83 is a GUI component for canceling the selection. Note that this is merely an example of the UI screen, and the UI screen displayed by the UI processing section 162 need only be a UI screen that displays the print languages usable by the printer 200 and that accepts the selection, and is not limited to the example shown in FIG. 3. Note that the UI screen shown in FIG. 3 is an example of the UI screen when the print languages usable by the printer 200 are three types, namely, a vendor standard language, Printer Command Language (PCL), and PostScript (PS). Here, the vendor standard language is a print language including a command uniquely defined by the vendor of the printer 200, and can also be referred to as a print language dedicated to the printer 200 manufactured by a specific vendor. Therefore, in general, as compared with other print languages that are used in a general-purpose manner such as PS and PCL, the vendor standard language is a print language that enables functions of the printer 200 to be used to a greater extent.

The print data conversion section 163 converts print data of a predetermined data format received from the general-purpose printer driver 151, that is, print data expressed in a predetermined print language, into print data expressed in the print language accepted by the UI processing section 162. In the present embodiment, as an example, print data that the printing control program (the print data conversion section 163) receives from the general-purpose printer driver 151 is data in an Extensible Markup Language (XML) Paper Specification (XPS) format (hereinafter also referred to as XPS data or simply XPS). For example, when the user selects PS as the print language that the user desires to use via the UI screen 80 shown in FIG. 3, the print data conversion section 163 converts the XPS data received from the general-purpose printer driver 151 into PS-format print data.

The transmission processing section 164 performs transmission processing of transmitting, to the printer 200, print data in accordance with the selected print language. That is, the transmission processing section 164 performs processing of transmitting, to the printer 200, print data converted by the print data conversion section 163. Specifically, the transmission processing section 164 causes the general-purpose printer driver 151 to execute transmission to the printer 200 of the print data in accordance with the selected print language. That is, the transmission processing section 164 passes the print data converted by the print data conversion section 163 to the general-purpose printer driver 151 and causes the general-purpose printer driver 151 to execute transmission to the printer 200.

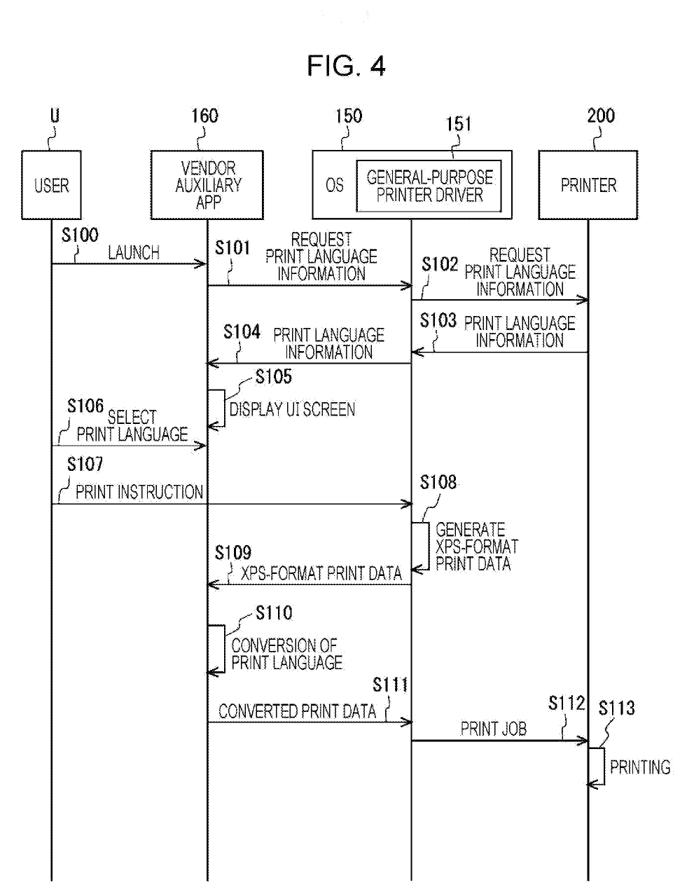

Next, an operation example of the printing system 1 of the present embodiment will be described. FIG. 4 is a sequence chart showing an example of the operation of the printing system 1 according to Embodiment 1. Hereinafter, the operation example of the printing system 1 will be described with reference to the sequence chart shown in FIG. 4.

In step S100, a user U operates the input portion 131 to launch the vendor auxiliary App 160, that is, the above-described printing control program. The launch of the vendor auxiliary App 160 may be implemented by the user U performing a predetermined operation on the UI screen provided by an application program that performs processing on data to be printed. In this case, by the general-purpose printer driver 151 that is called from the application program, the general-purpose printer driver 151 may be launched. For example, the predetermined operation may be an operation of a button for displaying properties of the printer used for printing. The application program for performing processing on the data to be printed is, for example, document editing software, spreadsheet software, image editing software, photo display software, or the like, but the present disclosure is not limited to these. The vendor auxiliary App 160 may be launched without passing through the application program that performs processing on the data to be printed. That is, the user U may perform a predetermined operation to directly launch the vendor auxiliary App 160.

In step S101, in order to acquire the print language information indicating the print languages usable by the printer 200 used for printing, the acquisition processing section 161 of the vendor auxiliary App 160 requests the general-purpose printer driver 151 for the print language information.

Next, in step S102, in response to the request from the vendor auxiliary App 160, the general-purpose printer driver 151 requests the printer 200 for the print language information. In response thereto, in step S103, in response to the request from the general-purpose printer driver 151, the printer 200 transmits the print language information of the printer 200 to the general-purpose printer driver 151 (the information processing apparatus 100), and the general-purpose printer driver 151 acquires the print language information. The general-purpose printer driver 151 performs communication between the information processing apparatus 100 and the printer 200 through, for example, communication in accordance with IPP. Next, in step S104, in response to the acquisition of the print language information from the printer 200, the general-purpose printer driver 151 outputs the acquired print language information to the vendor auxiliary App 160. Consequently, the acquisition processing section 161 of the vendor auxiliary App 160 acquires the print language information indicating the print languages usable by the printer 200 used for printing. Since there is a possibility that the printer 200 to be used is changed by the user, the acquisition processing of the print language information may be re-executed at any timing.

Next, in step S105, the UI processing section 162 of the vendor auxiliary App 160 displays the UI screen including, as options, the print languages indicated by the print language information acquired in step S104. Then, in step S106, the UI processing section 162 accepts selection by the user U regarding the print language.

Next, in step S107, the user U operates the input portion 131 to input to the information processing apparatus 100 a print instruction regarding data to be printed, that is, a file to be printed. This input of the print instruction may be implemented, for example, by the user U performing a predetermined operation on the UI screen provided by the application program that performs processing on the data to be printed, but may be implemented by a predetermined operation on the UI screen provided by the general-purpose printer driver 151 or the vendor auxiliary App 160.

The OS 150 is notified of the input print instruction, and in step S108, the OS 150 generates XPS data, which is XPS-format print data, based on the data to be printed. The OS 150 then passes the generated XPS data to the general-purpose printer driver 151. Next, in step S109, the general-purpose printer driver 151 outputs the XPS data to the vendor auxiliary App 160.

Next, in step S110, in response to the acquisition of the XPS data from the general-purpose printer driver 151, the print data conversion section 163 of the vendor auxiliary App 160 performs conversion processing on the XPS data. That is, the print data conversion section 163 performs processing of converting the print language. Specifically, the print data conversion section 163 converts the XPS data into print data expressed in the print language selected in step S106.

Next, in step S111, the transmission processing section 164 of the vendor auxiliary App 160 outputs the print data converted in step S110 to the general-purpose printer driver 151 in order to transmit the print data to the printer 200, and requests the general-purpose printer driver 151 to execute transmission to the printer 200.

Next, in step S112, the general-purpose printer driver 151 transmits, to the printer 200, a print job including the print data converted in step S110. Then, in step S113, the printer 200 executes printing in accordance with the print data converted in step S110.

Embodiment 1 is described above. In the present embodiment, the vendor auxiliary App 160 (the printing control program) acquires the information indicating the print languages usable by the printer 200, displays the UI screen for selecting the print language, and accepts selection of the print language by the user. Then, the print data in accordance with the selected print language is transmitted to the printer 200. Therefore, according to Embodiment 1, printing can be performed by freely setting a print language to use. Depending on the print language, differences may occur in throughput of transmission of print data and in printing quality. Therefore, provision of a technology that enables free setting of the print language can improve usability.

### Modification Example

For the above-described embodiment, the following modification example can also be provided. The modification example will be described below. Points different from the above-described embodiment will be described, and description regarding overlapping configurations or processing will be omitted as appropriate.

When performing printing by the printer 200, the user may designate various print settings. However, depending on the selected print language, a print setting that cannot be implemented may exist. For example, image processing for adjusting image quality and the like may be supported only by some print languages such as the vendor standard language. In this case, when a different print language is selected, a print setting that requires the image processing cannot be implemented. Therefore, it is required to explicitly notify the user of a print setting that can be designated and a print setting that cannot be designated in accordance with the selected print language. In the present modification example, the print setting refers to any setting regarding printing excluding the print language.

Accordingly, in the present modification example, the above-described printing control program further provides the following function. Specifically, in the present modification example, the UI processing section 162 further performs the following processing.

The UI processing section 162 specifies a print setting not supported by the selected print language. Note that this processing can be implemented, for example, by using definition information that, for each print language, indicates a print setting supported by the print language or a print setting not supported by the print language. In this case, the UI processing section 162 refers to the definition information and specifies the print setting not supported by the selected print language. In addition, such definition information may be acquired from the printer 200 by an acquisition process similar to the acquisition of the print language information.

Further, the UI processing section 162 displays, as the UI screen for the print setting, on the display portion 132, a UI screen in which a display regarding the print setting supported by the selected print language and a display regarding the print setting not supported by the selected print language are made different. Consequently, the user U can easily ascertain which print setting is usable and which print setting is not usable. Then, the UI processing section 162 accepts, from the user, an instruction to apply the print setting supported by the selected print language. That is, the UI processing section 162 accepts only an instruction to apply the print setting supported by the selected print language and does not accept an instruction to apply the print setting not supported by the selected print language. Then, the transmission processing section 164 performs transmission processing of transmitting, to the printer 200, print data in accordance with the selected print language and the print setting as instructed. Specifically, the transmission processing section 164 causes the general-purpose printer driver 151 to execute transmission to the printer 200 of the print data in accordance with the selected print language and the print setting as instructed.

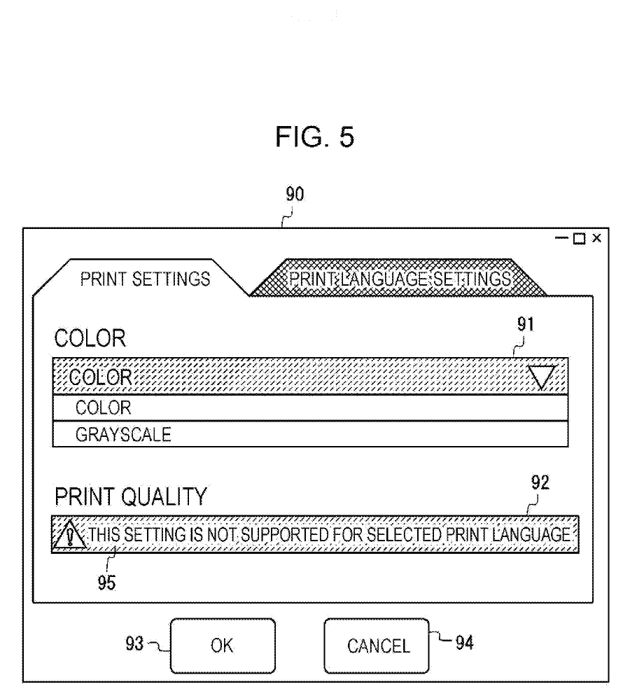

FIG. 5 is a schematic diagram showing an example of a UI screen 90 regarding designation of the print setting. The UI processing section 162 displays, as the UI screen for the print setting, for example, the UI screen 90 as shown in FIG. 5 on the display portion 132 (that is, a display). In the example shown in FIG. 5, a print setting regarding color printing is a print setting supported by the selected print language, whereas a print setting regarding printing quality is a print setting not supported by the selected print language. The UI screen 90 shown as an example in FIG. 5 is a so-called GUI and includes a pull-down menu 91, a pull-down menu 92, a button 93, and a button 94. The pull-down menu 91 is a GUI component for the print setting regarding color printing. The pull-down menu 92 is a GUI component for the print setting regarding printing quality. The button 93 is a GUI component for confirming designation of the print setting. The button 94 is a GUI component for canceling designation of the print setting. In the example of FIG. 5, the pull-down menu 91 regarding color printing is displayed as a GUI component in which a setting item can be designated. On the other hand, the pull-down menu 92 regarding printing quality is displayed as a GUI component in which a setting item cannot be designated. In this manner, the UI processing section 162 may display, for the print setting supported by the selected print language, the GUI component in which a setting item can be designated, and display, for the print setting not supported by the selected print language, the GUI component in which a setting item cannot be designated. Additionally, as shown in FIG. 5, regarding the print setting not supported by the selected print language, the UI processing section 162 may display a warning message 95 to inform the user that the print setting is a print setting not supported by the selected print language. In this manner, in the modification example, the UI processing section 162 displays the UI screen in which the display regarding the print setting supported by the selected print language and the display regarding the print setting not supported by the selected print language are made different. Note that FIG. 5 is merely an example of the UI screen, and the UI screen regarding the print setting that the UI processing section 162 displays is not limited to the example shown in FIG. 5 as long as the UI screen is a UI screen in which the display regarding the print setting supported by the selected print language and the display regarding the print setting not supported by the selected print language are made different.

The modification example is described above. In the present modification example, as the UI screen for the print setting, a UI screen in which the display regarding the print setting supported by the selected print language and the display regarding the print setting not supported by the selected print language are made different is displayed. Therefore, even when the print settings supported by the print languages are different, the user can easily ascertain which print setting is a usable print setting and which print setting is an unusable print setting. Therefore, usability can be improved.

### Embodiment 2

Next, Embodiment 2 will be described. In Embodiment 1, a print language to use is selected by the user; however, a print language to use may be automatically selected. In the present embodiment, an information processing apparatus 100 having a function capable of automatically selecting a print language to use will be described.

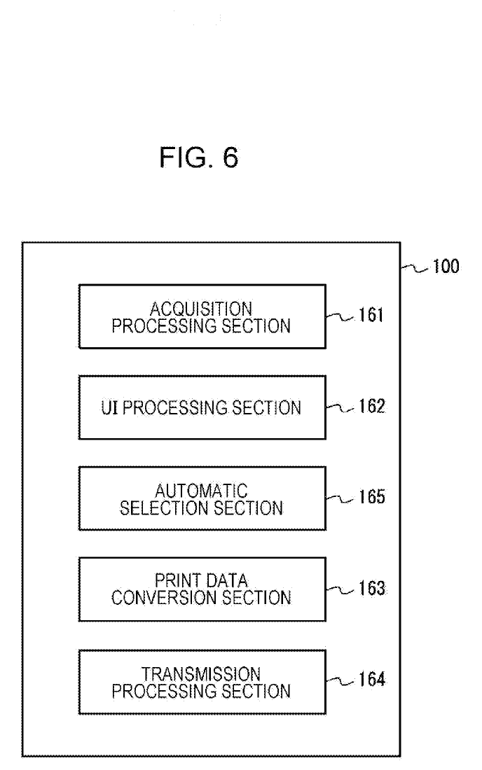

In the present embodiment, in addition to the functions described in Embodiment 1, the printing control program further includes a function to be described below. Similarly to Embodiment 1, in the present embodiment, the printing control program can also be implemented, for example, as a PSA. In the present embodiment, the printing control program is a printing control program for extending the general-purpose printer driver 151 and for causing the computer (that is, the information processing apparatus 100) to have the functions shown in FIG. 6. FIG. 6 is a block diagram showing components provided in the information processing apparatus 100 according to Embodiment 2 as functions of the printing control program.

As shown in FIG. 6, the information processing apparatus 100 according to Embodiment 2 is different from the information processing apparatus 100 shown in FIG. 2 in that, as the functions of the printing control program, an automatic selection section 165 is further provided. Therefore, in the present embodiment, the printing control program causes the information processing apparatus 100 (computer) to execute processing of the acquisition processing section 161, the UI processing section 162, the automatic selection section 165, the print data conversion section 163, and the transmission processing section 164. In other words, by the processing section 110 of the information processing apparatus 100 executing the printing control program, the processing of the acquisition processing section 161, the UI processing section 162, the automatic selection section 165, the print data conversion section 163, and the transmission processing section 164 is executed. Note that processing as the automatic selection section 165 may also be referred to as automatic selection processing.

In the present embodiment, as the UI screen for the selection of the print language, the UI processing section 162 displays a UI screen that further includes an option for issuing an instruction for automatic selection of the print language. Therefore, in the present embodiment, the user can instruct the information processing apparatus 100 to perform automatic selection. When the user desires the information processing apparatus 100 to select the print language instead of the user selecting the print language, the user selects, from among options displayed on the UI screen, an option for issuing an instruction for automatic selection.

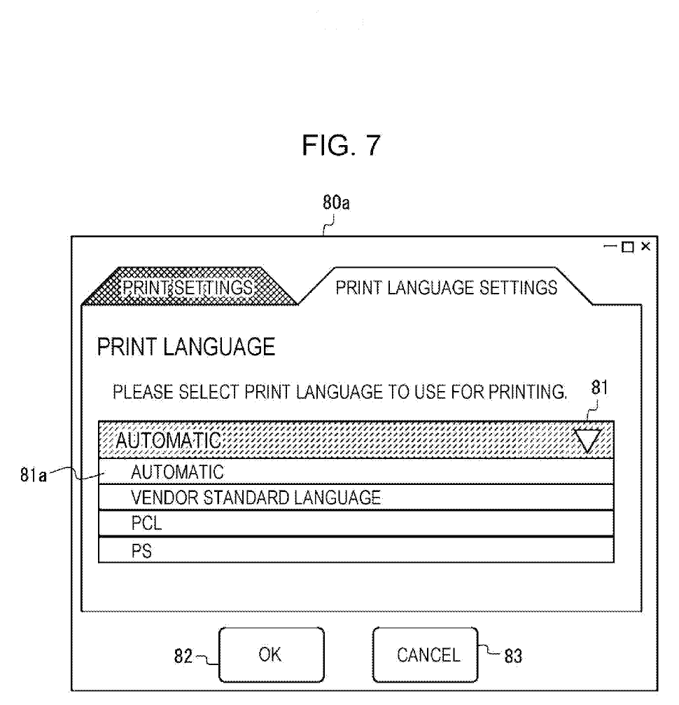

FIG. 7 is a schematic diagram showing an example of a UI screen 80a for selection of the print language. In the present embodiment, when the acquisition processing section 161 acquires the print language information of the printer 200, the UI processing section 162 displays, for example, the UI screen 80a as shown in FIG. 7 on the display portion 132 (that is, the display). The UI screen 80a shown in FIG. 7 is different from the UI screen 80 shown in FIG. 3 in that the pull-down menu 81 further includes, in addition to options for designating the print language, an option 81a for issuing an instruction for automatic selection of the print language.

When an instruction for automatic selection of the print language is issued, that is, when the UI processing section 162 accepts an instruction for automatic selection, the automatic selection section 165 selects, in accordance with a predetermined selection rule, a print language from among the print languages usable by the printer 200. That is, the automatic selection section 165 determines a print language to use. For example, in the example shown in FIG. 7, from among three types of print languages, namely, the vendor standard language, PCL, and PS, the automatic selection section 165 selects a print language in accordance with the predetermined selection rule. As a result, even when the user does not select the print language, an appropriate print language that the printer 200 can process can be selected.

The predetermined selection rule need only be a rule determined in advance, and, as the predetermined selection rule, for example, the following selection rule may be used. That is, the automatic selection section 165 may select a print language as follows.

When the print data acquired from the general-purpose printer driver 151 includes image drawing such as a photograph, the automatic selection section 165 may select, out of the print languages usable by the printer 200, a predetermined print language whose characteristic regarding image printing quality satisfies a predetermined criterion. The predetermined criterion used here is a criterion indicating a level of printing quality. For example, in this case, the automatic selection section 165 selects PS, which is a print language that enables high-quality image printing as compared with other print languages. In order to perform such selection, the automatic selection section 165 may analyze, for example, the print data (XPS data) acquired from the general-purpose printer driver 151 and determine whether or not the data to be printed includes an image. Note that, since the print data acquired from the general-purpose printer driver 151 is described by a predetermined description method in accordance with a predetermined print language (XPS), easy analysis is possible. By automatically selecting the print language in accordance with such a selection rule, high-quality printing can be achieved.

In addition, when a communication speed between the information processing apparatus 100 and the printer 200 is less than a predetermined speed, the automatic selection section 165 may select, out of the print languages usable by the printer 200, a predetermined print language whose characteristic regarding an amount of data satisfies a predetermined criterion. That is, when a communication environment is poor, the automatic selection section 165 selects a predetermined print language whose characteristic regarding the amount of data satisfies the predetermined criterion. The predetermined criterion used here is a criterion indicating smallness of the amount of data of the print data. For example, in this case, the automatic selection section 165 selects PCL, which is a print language that enables reduction in a data size of print data as compared with other print languages. Consequently, it is possible to reduce a waiting time until printing is executed. In order to perform such automatic selection of a language, the automatic selection section 165 may estimate the communication speed of communication between the information processing apparatus 100 and the printer 200. For example, the automatic selection section 165 may estimate the communication speed from a time since a request for the print language information is output from the vendor auxiliary App 160 (printing control program) until the vendor auxiliary App 160 (printing control program) acquires the print language information. That is, the automatic selection section 165 may estimate the communication speed of communication between the information processing apparatus 100 and the printer 200 based on the time from when step S101 described above is executed until step S104 is executed. Note that the estimation of the communication speed of communication between the information processing apparatus 100 and the printer 200 need not be performed by the vendor auxiliary App 160 (printing control program). The automatic selection section 165 may acquire the communication speed of communication between the information processing apparatus 100 and the printer 200, which is measured by another component of the information processing apparatus 100. In this manner, the automatic selection section 165 need only acquire the communication speed by using any method.

In addition, out of the print languages usable by the printer 200, the automatic selection section 165 may select a print language that supports a print setting as instructed by the user. That is, when the user U issues an instruction for a print setting to be applied to printing, the automatic selection section 165 selects a print language that supports the print setting as instructed. For example, when the print setting as instructed by the user is a print setting that is implementable using the vendor standard language, the automatic selection section 165 selects the vendor standard language. In order to perform such selection, the automatic selection section 165 may perform processing of checking which print language supports the print setting accepted by the UI processing section 162 from the user. In this processing, the above-described definition information, that is, definition information that, for each print language, indicates the print setting supported by the print language, may be used. In this case, the automatic selection section 165 refers to the definition information and specifies the print language that supports the print setting as instructed by the user. By automatically selecting the print language in accordance with such a selection rule, printing using a print setting desired by the user can be achieved.

Note that the above-described automatic selection is merely an example, and the automatic selection section 165 may select a print language in accordance with another selection rule. For example, the automatic selection section 165 may select a print language in accordance with a priority order determined in advance for various print languages that may be used as candidates for the print languages usable by the printer 200. For example, when the print language cannot be determined by the above-described selection rule, the automatic selection section 165 may select the print language in accordance with a predetermined priority order.

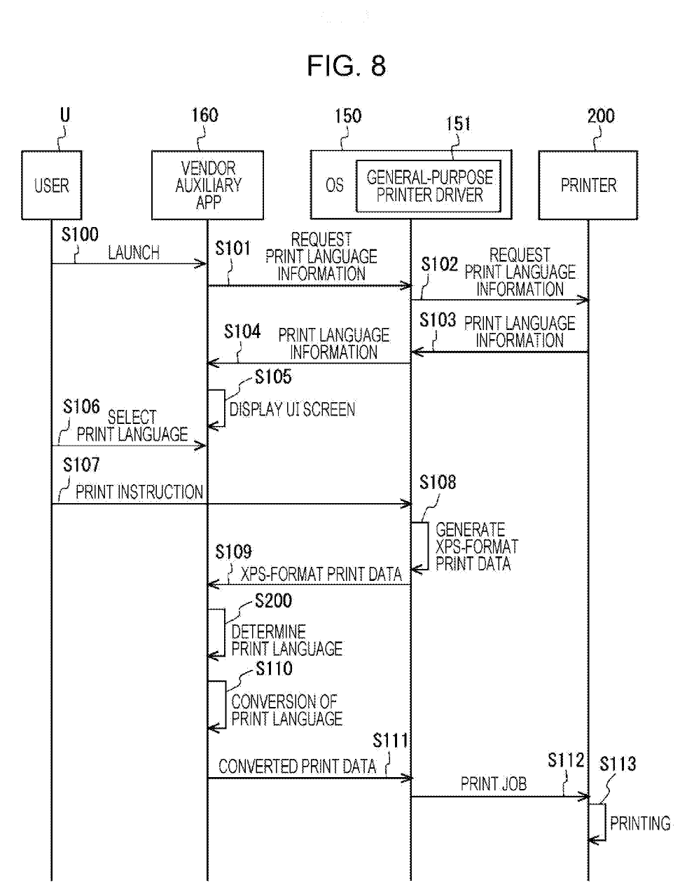

Next, an operation example of the printing system 1 of the present embodiment will be described. FIG. 8 is a sequence chart showing an example of the operation of the printing system 1 according to Embodiment 2. The sequence chart shown in FIG. 8 is different from the sequence chart shown in FIG. 4 in that step S200 is added. In the sequence chart shown in FIG. 8, it is assumed that, in step S106, an option for issuing an instruction for automatic selection is selected as selection by the user U regarding the print language. Hereinafter, differences from the sequence chart shown in FIG. 4 will be described.

In the sequence chart shown in FIG. 8, step S200 is performed before step S110. In the sequence chart shown in FIG. 8, as an example, step S200 is performed after step S109, but step S200 may be performed at any timing before step S110.

In step S200, the automatic selection section 165 determines a print language to use in accordance with the predetermined selection rule. The automatic selection section 165 performs processing of determining the print language as necessary. That is, for example, as described above, the automatic selection section 165 performs analysis processing of the XPS data, estimation processing of the communication speed, specification processing of the print language that supports the print setting as instructed by the user U, and the like.

After step S200, step S110 is performed. In step S110, the print data conversion section 163 of the vendor auxiliary App 160 converts the XPS data into the print data expressed in the print language determined in step S200. Subsequent processing is as described with reference to FIG. 4.

Embodiment 2 is described above. In the present embodiment, an automatic selection function of the print language is provided. Therefore, usability can be improved. Note that the modification example described above may be combined with Embodiment 2.

The present disclosure is not limited to the above-described embodiments and can be changed as appropriate within a scope not departing from the gist. For example, in the above-described embodiments, a case is described in which the OS 150 is Windows, but the OS 150 is not limited to Windows and may be, for example, any operating system such as macOS (registered trademark) or Linux (registered trademark).

Additionally, in the present disclosure, a program includes a group of commands (or software code) for causing a computer to perform one or more functions described in the embodiments when read by the computer. The program may be stored in a non-transitory computer-readable medium or a tangible storage medium. By way of example and not limitation, the computer-readable medium or the tangible storage medium includes a random-access memory (RAM), a read-only memory (ROM), a flash memory, a solid-state drive (SSD) or other memory technologies, a CD-ROM, a digital versatile disc (DVD), a Blu-ray (registered trademark) disc or other optical disc storages, a magnetic cassette, a magnetic tape, a magnetic disk storage or other magnetic storage devices. The program may be transmitted on a transitory computer-readable medium or on a communication medium. By way of example and not limitation, the transitory computer-readable medium or the communication medium includes electrical, optical, acoustic, or other forms of propagated signals. Further, the program is included in a computer program product.

In addition, some or all of the above-described embodiments or modification examples may be described as the following supplementary notes, but are not limited to the following.

### Supplementary Note 1

A non-transitory computer-readable storage medium storing a printing control program for extending a general-purpose printing program, the printing control program causing a computer to execute:

acquisition processing of acquiring information indicating print languages usable by a printer;

user interface processing of displaying a first user interface screen including, as options, the print languages indicated by the information, and accepting selection by a user regarding the print language; and

transmission processing of transmitting, to the printer, print data in accordance with the selected print language.

### Supplementary Note 2

The non-transitory computer-readable storage medium according to Supplementary Note 1, in which

the printing control program is a print support application.

### Supplementary Note 3

The non-transitory computer-readable storage medium according to Supplementary Note 1 or 2, in which

the user interface processing further includes:

processing of specifying a print setting not supported by the selected print language;

processing of displaying a second user interface screen in which a display regarding a print setting supported by the selected print language and a display regarding the print setting not supported by the selected print language are made different; and

processing of accepting an instruction to apply the print setting supported by the selected print language, and

the transmission processing is processing of transmitting, to the printer, the print data in accordance with the selected print language and the print setting as instructed.

### Supplementary Note 4

The non-transitory computer-readable storage medium according to any one of Supplementary Notes 1 to 3, in which

in the user interface processing, the first user interface screen further including an option for issuing an instruction for automatic selection of the print language is displayed, and

the printing control program further causes the computer to execute automatic selection processing of, when the instruction for the automatic selection of the print language is issued, selecting the print language from the print languages usable by the printer, in accordance with a predetermined selection rule.

### Supplementary Note 5

The non-transitory computer-readable storage medium according to Supplementary Note 4, in which

in the automatic selection processing, when print data acquired from the general-purpose printing program includes image drawing, out of the print languages usable by the printer, a predetermined print language whose characteristic regarding image printing quality satisfies a predetermined criterion is selected.

### Supplementary Note 6

The non-transitory computer-readable storage medium according to Supplementary Note 4 or 5, in which

in the automatic selection processing, when a communication speed between the computer and the printer is less than a predetermined speed, out of the print languages usable by the printer, a predetermined print language whose characteristic regarding an amount of data satisfies a predetermined criterion is selected.

### Supplementary Note 7

The non-transitory computer-readable storage medium according to any one of Supplementary Notes 4 to 6, in which

in the automatic selection processing, out of the print languages usable by the printer, a print language that supports a print setting as instructed by the user is selected.

### Supplementary Note 8

An information processing apparatus including a general-purpose printing program and a printing control program for extending the general-purpose printing program, the information processing apparatus including, as functions of the printing control program:

an acquisition processing section that acquires information indicating print languages usable by a printer;

a user interface processing section that displays a first user interface screen including, as options, the print languages indicated by the information, and accepts selection by a user regarding the print language; and

a transmission processing section that transmits, to the printer, print data in accordance with the selected print language.

### Supplementary Note 9

A control method including:

causing a computer including a general-purpose printing program and a printing control program for extending the general-purpose printing program to execute, by execution of the printing control program:

acquisition processing of acquiring information indicating print languages usable by a printer;

user interface processing of displaying a first user interface screen including, as options, the print languages indicated by the information, and accepting selection by a user regarding the print language; and

transmission processing of transmitting, to the printer, print data in accordance with the selected print language.

What is claimed is:

1. A non-transitory computer-readable storage medium storing a printing control program for extending a general-purpose printing program, the printing control program causing a computer to execute:
acquisition processing of acquiring information indicating print languages usable by a printer;
user interface processing of displaying a first user interface screen including, as options, the print languages indicated by the information, and accepting selection by a user regarding the print language; and
transmission processing of transmitting, to the printer, print data in accordance with the selected print language.

2. The non-transitory computer-readable storage medium according to claim 1, wherein
the printing control program is a print support application.

3. The non-transitory computer-readable storage medium according to claim 1, wherein
the user interface processing further includes:
processing of specifying a print setting not supported by the selected print language;
processing of displaying a second user interface screen in which a display regarding a print setting supported by the selected print language and a display regarding the print setting not supported by the selected print language are made different; and
processing of accepting an instruction to apply the print setting supported by the selected print language, and
the transmission processing is processing of transmitting, to the printer, the print data in accordance with the selected print language and the print setting as instructed.

4. The non-transitory computer-readable storage medium according to claim 1, wherein
in the user interface processing, the first user interface screen further including an option for issuing an instruction for automatic selection of the print language is displayed, and
the printing control program further causes the computer to execute automatic selection processing of, when the instruction for the automatic selection of the print language is issued, selecting the print language from the print languages usable by the printer, in accordance with a predetermined selection rule.

5. The non-transitory computer-readable storage medium according to claim 4, wherein
in the automatic selection processing, when print data acquired from the general-purpose printing program includes image drawing, out of the print languages usable by the printer, a predetermined print language whose characteristic regarding image printing quality satisfies a predetermined criterion is selected.

6. The non-transitory computer-readable storage medium according to claim 4, wherein
in the automatic selection processing, when a communication speed between the computer and the printer is less than a predetermined speed, out of the print languages usable by the printer, a predetermined print language whose characteristic regarding an amount of data satisfies a predetermined criterion is selected.

7. The non-transitory computer-readable storage medium according to claim 4, wherein
in the automatic selection processing, out of the print languages usable by the printer, a print language that supports a print setting as instructed by the user is selected.

8. An information processing apparatus including a general-purpose printing program and a printing control program for extending the general-purpose printing program, the information processing apparatus comprising, as functions of the printing control program:
an acquisition processing section that acquires information indicating print languages usable by a printer;
a user interface processing section that displays a first user interface screen including, as options, the print languages indicated by the information, and accepts selection by a user regarding the print language; and
a transmission processing section that transmits, to the printer, print data in accordance with the selected print language.

9. A control method comprising:
causing a computer including a general-purpose printing program and a printing control program for extending the general-purpose printing program to execute, by execution of the printing control program:
acquisition processing of acquiring information indicating print languages usable by a printer;
user interface processing of displaying a first user interface screen including, as options, the print languages indicated by the information, and accepting selection by a user regarding the print language; and
transmission processing of transmitting, to the printer, print data in accordance with the selected print language.
